(19) United States
(12) Patent Application Publication
(10) Pub. No.: US 2015/0000382 A1
(43) Pub. Date: Jan. 1, 2015

(54) METHOD AND SYSTEM FOR DETECTING A LEAK OF FLUID FROM A FLUID-CARRYING DUCT

(71) Applicant: DR. FRUCHT SYSTEMS LTD., Acco, IL (US)

(72) Inventor: Yaacov FRUCHT, Acco (IL)

(21) Appl. No.: 14/317,908

(22) Filed: Jun. 27, 2014

(30) Foreign Application Priority Data
Jul. 1, 2013 (IL) 227289

(51) Int. Cl. G01M 3/38

(52) U.S. Cl. CPC G01M 3/38
USPC 73/49.1

(57) ABSTRACT

A method and a system for the detection of leaked fluid that leaked out of a fluid-carrying duct associated with at least one optical conductor. The method and the system monitor an aboveground portion of the duct along which the optical conductor runs. The mechanical mechanism includes a leaked-fluid collector configured to collect the leaked fluid, a leak-operated device configured to respond to the leaked fluid, and a strain application structure configured to use the leak-operated device to apply a strain deformation on the at least one optical conductor. The monitored leaks include leaks of liquid and leaks of pressurized gas. The leak-operated device is buoyant on the leaked fluid, or is a substance that expands in liquid, or is a hermetically sealed chamber.

### TECHNICAL FIELD

The method and system refer to the ability to detect and report a leak of fluid out of a duct carrying fluid, and in particular, for detecting a leak of liquid or of pressurized gas out of a duct by use of an optical conductor.

### BACKGROUND ART

The use of fiber optics for operation with pipelines is well known per se. For example, US Patent Application Publication No. 2007/0131297 discloses such an ability but for use with offshore hose lines. However, a simple mechanical mechanism configured to assist the detection of leaks from a pipeline, and also enabling the retrofit of existing pipeline installations is not is divulged.

### SUMMARY OF INVENTION

### Technical Problem

It is well known that ducts of fluid or pipelines may be protected against intrusion by fiber optics running along those ducts. However, in addition to protection against intrusion, it is also desirable to detect and report leaks of fluid out of a duct. It would thus be beneficial to take advantage of the fiber optics used for the detection of intrusion for example, for the detection of leaks.

### Solution to Problem

The solution is provided by a mechanism which takes advantage of the available intrusion detection and reporting optical conductor(s) to detect and report leaks of fluid by help of associated emitter(s) and receiver(s) and appropriate electronics. More specifically, the accumulation of leaked liquid or gas under pressure may cause a mechanical device to apply a deformation strain on the fiber optics, which strain may be detected and reported.

### Advantageous Effects of Invention

The solution to the problem described herein is a simple mechanical mechanism whereby the advantages of optical fibers are retained. To name just one example out of the advantages amongst others, like optical fibers, the solution described herein is able to operate without electricity for safe use in the presence of flammable and explosive substances or in environments carrying flammable and/or explosive gasses.

It is an object of the present invention of the present invention to provide a method and a system for detecting fluid leaking out of a fluid-carrying duct operating in association with at least one optical conductor. The method may include providing a leaked-fluid collector for collecting fluid leaking out of the duct, providing a leak-operated device responding to fluid that leaked out of the duct, and providing a strain application structure using the leak-operated device for applying strain deformation on the at least one optical conductor.

The leaked-fluid collector accumulates fluid that is either a liquid or a pressurized gas, and is disposed to envelope a monitored aboveground portion of the duct.

It is another object of the present invention of the present invention to provide a mechanical force application mechanism which applies strain on the at least one optical conductor.

It is still another object of the present invention of the present invention to provide a leak-operated device that is buoyant on the leaked fluid, or that is a substance that expands in liquid, or is configured as a hermetically sealed chamber.

There is provided a system for the detection of leaked fluid that leaked out of a fluid-carrying duct associated with at least one optical conductor. The system operates a mechanical mechanism including a leaked-fluid collector configured to collect the leaked fluid, a leak-operated device that responds to the leaked fluid, and a strain application structure that uses the leak-operated device to apply a strain deformation on the at least one optical conductor.

### BRIEF DESCRIPTION OF DRAWINGS

In the drawings, like reference characters generally refer to the same parts throughout the different views. The drawings are schematic and not to scale, emphasis instead generally being placed upon illustrating the principles of the invention. Various non-limiting embodiments of the present invention are described with reference to the following description of exemplary embodiments, in conjunction with the figures in which:

FIG. 1 is a block diagram of a system,

FIGS. 2 and 3 show a schematic exemplary embodiment 100,

FIGS. 4 and 5 illustrate a target block,

FIG. 6 shows a schematic exemplary embodiment 200,

FIG. 7 depicts a further schematic exemplary embodiment 300,

FIG. 8 depicts another schematic exemplary embodiment 400,

FIG. 9 illustrates a block diagram of another embodiment 500,

FIG. 10 illustrates still another schematic exemplary embodiment 600, and

FIG. 11 illustrates yet another exemplary schematic embodiment 700.

### DESCRIPTION OF EMBODIMENTS

The invention will now be described by way of exemplary embodiments which are provided for the sake of a clear explanation, and are not themselves intended to show the complete scope of the invention, which should be interpreted in the light of the appended claims.

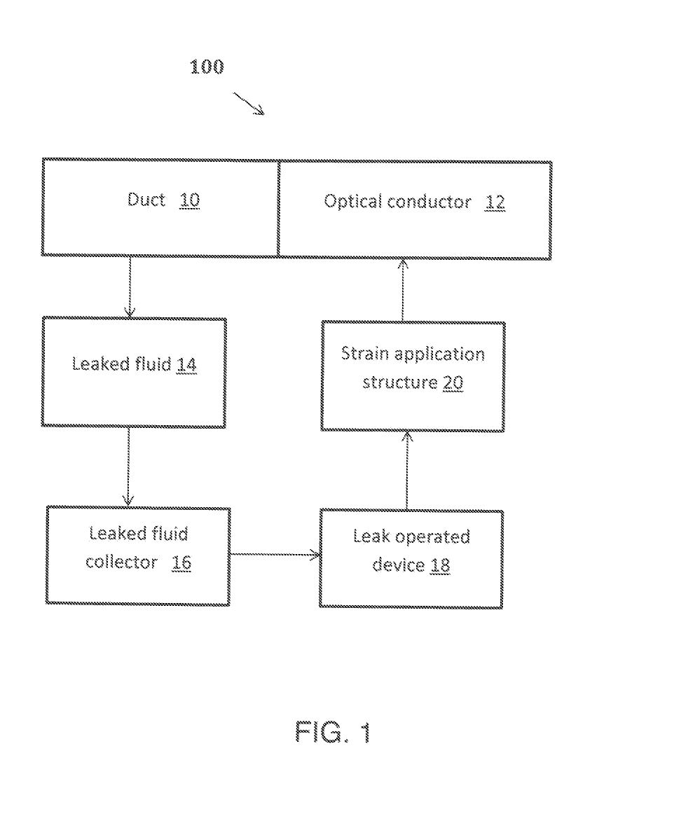

FIG. 1 is an exemplary block diagram of a system having a duct 10 along which runs an optical conductor 12. The duct 10 may be a pipeline and the optical conductor 12 may be an optical fiber or a fiber optic cable.

In FIG. 1, fluid that may leak out of a monitored portion of the duct 10 as leaked fluid 14 is collected in a leaked-fluid collector 16. A leak operated device 18 may respond to the presence of the leaked fluid 14 and may operate a strain application structure 20. When driven by the leak operated device 18, the strain application structure 20 may apply a deformation strain on the optical conductor 12. Hence, leaked fluid 14 causes the optical conductor 12 to endure deformation, which as is well known, may be detected and reported. Thereby leaks of fluid, or leaked fluid 14, may be detected and reported via an optical conductor 12. Such detection and report are also practical even in retrofit of existing installations which are not dedicated to report leaks.

The term liquid is meant to include substances featuring the properties of liquids and/or substances conveyed by a duct or a pipeline, whether the liquid is under pressure or not.

The detection and report of a leak of fluid may be achieved by use of appropriate electro-optical instrumentation disposed at least one end of the optical conductor 12. For example, although not shown in the Figs., one may consider an emitter device and a reception device disposed each at one end of the optical conductor 12 and operating in association with appropriate electronics.

In practice, with underground ducts 10 being protected against intrusion by fiber optics, leaks usually occur in the aboveground portion of the duct, almost always at the coupling of a duct fitting 10C, such as flanges and valves and other duct control apparatus for example. Reference herein of the detection of a leak out of an aboveground monitored portion of a duct 10 means detection of a leak out of leaking device(s) coupled to the duct 10 or out of the duct pipe itself. In the present description the Figs. refer to aboveground monitored portions of the duct 10.

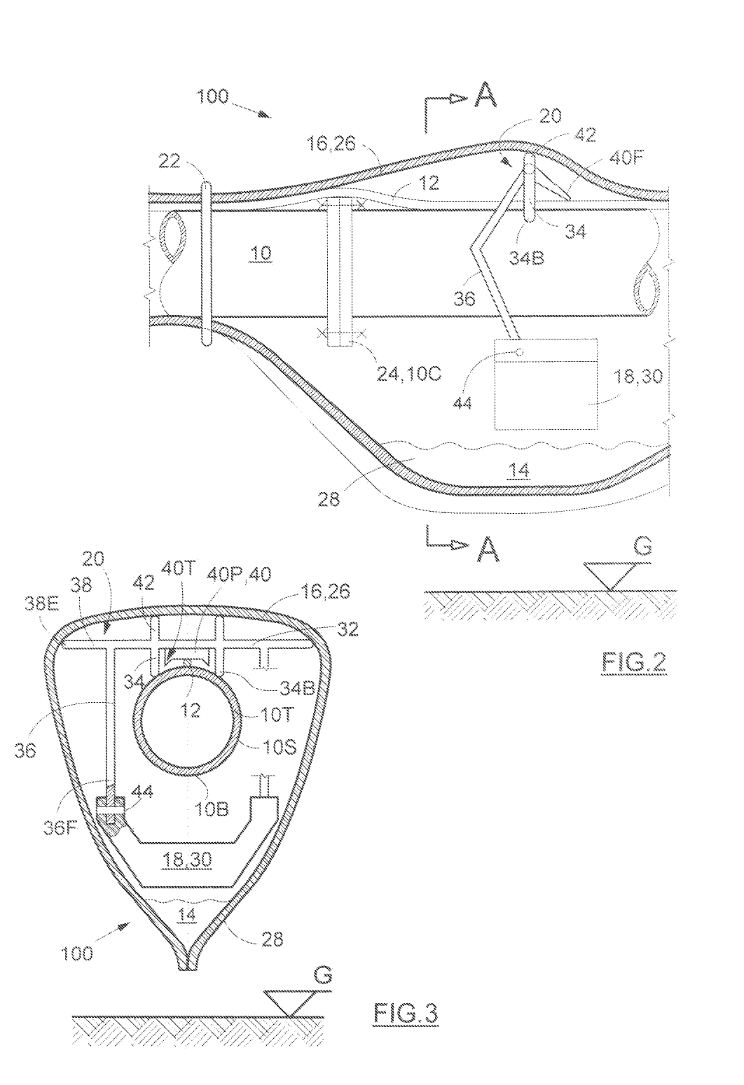

FIGS. 2 and 3 show a schematic exemplary embodiment 100 for detecting a leak of fluid out of a monitored aboveground portion of a duct 10 conducting liquid for example, along which runs an optical conductor 12 FIGS. 2 and 3 further depict leaked fluid 14, a leaked-fluid collector 16, a leak operated device 18, and a strain application structure 20. The duct 10 may have a duct fitting 10C such as a flange connection 24, which is selected for the sake of ease of drawing. A shroud 26, which forms the leaked-fluid collector 16 shown in FIG. 1, envelopes the selected portion of the duct 10, including the flange connection 24.

The shroud 26 may be chosen as a pliable and foldable sheet of fluid-tight matter, thus fluid impermeable material, which may be made out of natural or synthetic substance, or out of a combination thereof. The shroud 26 may be selected as fabric used in agriculture for example. If desired, the shroud 26 may be implemented as a semi-rigid material or as a rigid material or may be selected out of one or more of rigid material, semi-rigid material, and pliable and foldable sheet material.

Leaked fluid 14, for example liquid leaking out of a duct fitting 10C such as the flange connection 24, will collect in the bottom portion 28 of the shroud 26. The shroud 26 also envelopes the leak operated device 18, which may be chosen as an object possessing buoyancy features, such as a hollow hermetically sealed container, a solid body made of material buoyant on the fluid flowing in the duct 10, or as a combination thereof, forming a float 30. Such a float 30 may be made out of cork or out of foamed synthetic material for example. In the present embodiment the float 30 is coupled to the strain application structure 20 as shown in FIGS. 2 and 3.

FIG. 3 is a partial cross-section of FIG. 2 taken along the plane A-A that depicts the strain application structure 20, which is a rigid structure that straddles the top portion 10T of the duct 10 and both side portions 10S thereof. A beam 32 disposed above the duct top portion 10T, has two fingers 34 that reach down to the duct 10 and have each a finger bottom portion 34B that is disposed on and pivotally supported by the duct top portion 10T. Two legs 36 coupled to the beam 32 but disposed away from the duct 10, extend down and away from the beam 32 to reach below the bottom portion 10B of the duct 10. The free portion 36F of each one of the two legs 36 is coupled to the leak operated device 18, here float 30. It is also shown that an arm 38 having an arm end 38E extends in continuation of the beam 32, away from each one of the legs 36.

The directions top, bottom and side are relative to the duct 10, or pipe 10 and the ground G out of which the duct 10 exits. For a substantially horizontal portion of duct 10, the duct top portion 10T is a section of the duct circumference disposed above the duct bottom portion 10B, which is a section of the duct circumference closest to the ground G. The duct side portion 10S are those sections of duct circumference stretching between the duct top portion 10T and the duct bottom portion 10B.

A wedge 40, operative as a push wedge 40P, is coupled to the beam 32 between both fingers 34 and is disposed above the optical conductor 12 which may run along the duct top portion 10T. In the FIGS. 2 and 3, the push wedge 40P is disposed away from the fingers 34 and relative thereto, on the side opposite to the side of the legs 36. A pivotal rotation of the wedge 40 will squeeze the optical conductor 12 against the duct 10. Furthermore, an ear 42 is disposed in longitudinal alignment with but away from each one of both fingers 34, as shown in FIGS. 2 and 3. A wedge 40 may have wedge teeth 40T, shown in FIG. 3, which are protrusions intended to prevent the optical conductor 12 to slide away out of the reach of the wedge 40 during the application of force thereon.

The shroud 26 may be supported by and hangs down from the ears 42 and the arm ends 38E to reach below the float 30, where the shroud bottom portion 28 is controllably sealed. As described hereinbelow, the shroud bottom portion 28 may be hermetically sealed, or allow a predetermined leak of liquid thereout, or have openings for the free or controlled outflow of liquid.

FIGS. 2 and 3 illustrate how deformation or strain may be applied on the optical conductor 12 and how the strain application structure 20 may be pivotally supported in equilibrium on the duct 10. The legs 36 may be crooked or curved such that when coupled to the beam 32 and to the leak operated device 18, the strain application structure 20 may be balanced on the duct 10. Balance may be provided a priori during manufacture or may be achieved during installation by the appropriate addition of weights or by plastic deformation of the legs 36 for example. Alternatively, instead of being supported by the bottom portion 34B of the fingers, the strain application structure 20 may be coupled to the duct top portion 10T by one or more hinges, which are not shown in the Figs.

It is assumed that the strain application structure 20 shown in FIG. 2 is built in such a manner that when the float 30 becomes buoyant, the strain application structure 20, thus the beam 32 and the ears 42, will pivot clockwise relative to the bottom portion 34B of the fingers.

With the strain application structure 20 being pivotally supported by the duct 10, the push wedge 40P may be disposed close to but just away from applying a push-down force on the optical conductor 12. However, should leaked fluid 14 retained in the sealed bottom portion 28 of the shroud 26 lift the float 30 and pivot the strain application structure 20, clockwise in FIG. 2, about the bottom portion 38B of the arms 38 or about a hinge pivot, then the push wedge 40P will be forcefully applied onto and deform the optical conductor 12. As well known, a deformation of an optical fiber, here the optical conductor 12, is detectable and reportable, and may thus indicate a leak of fluid.

To implement the ability to detect a leak of fluid out of a duct 10 already equipped with fiber optics 12, even if intended to operate for a different purpose such as for example intrusion detection, the following series of steps may be taken, but not necessarily in the order of sequence described hereinbelow.

First there is selected an aboveground portion of duct 10 to be monitored, such as for example, a portion of duct 10 where a potential leak of fluid might occur. Often, a flange, or a valve, or other mechanical duct fittings 10C are prone to leak. Second, the strain application structure 20 is pivotally straddled over the optical conductor 12 running along the length of the top portion 10T of the duct 10, with the bottom portion 34B of each finger 34 being disposed on the duct on one side of the optical conductor. Third, the float 30 is coupled to the free portion 36F of the legs 36 by chemical fastening such as by an adhesive, or by mechanical fastening. A mechanical fastener 44 may be selected as a pin or a screw a shown in FIGS. 2 and 6, friction, or by interference fastening, or as a combination thereof. Adjustments may be made to ensure the desired balance that will provide the clockwise pivotal direction of the strain application structure 20 carrying the float 30, for example by appropriate bending of the legs 36 or by addition of balancing weights, which are not shown in the Figs.

Next, the collector of leaked-fluid 14, hence the leak collector 16, or shroud 26, may be loosely wrapped over the selected portion of duct 10 to permit free motion of the strain application structure 20. The shroud 26 is wrapped to enclose the duct fitting 10C, the strain application structure 20 with the ears 42 and arm ends 38E, and the leak operated device 18. The shroud 26 may be selected as a rectangular piece of material having a length and a width. The length of the shroud 26 may be disposed to straddle the duct top portion 10T. The longitudinal sides of the shroud 26 may be disposed to cover both sides 10S of the duct 10 and drop down well below the duct bottom portion 10B and the leak operated device 18. The longitudinal sides of the shroud 26 may be attached together to form a controllably sealed joint that may be partly or hermetically sealed if desired.

Should the bottom portion 28 of the shroud 26 be hermetical sealed, it may not be necessary to hermetically seal together the longitudinal sides of the shroud 26. One may rotate the shroud 26 about the duct 10 for the longitudinal sides thereof to be disposed above, over and along the duct top portion 10T. Thereby, the now bottom portion 28 being a continuous portion of the material will be able to hermetically retain leaked liquid 14 collected therein.

In turn, both lateral sides of the rectangular shroud 26 may be gathered together to be tightly wrapped around the duct 10 and to be retained closed together say by use of bands 22, straps 22, or of adhesive tape 22. However, care is taken not tightened the shroud 26 such as to prevent substantially free movement of the ears 42 of the strain application structure 20 and of the float 30. In addition, attention is given to appropriately dispose the shroud 26 so as to permit the collection and the retention of fluid in the bottom portion 28. Thereby, the shroud is draped over the duct 10 and covers the duct fitting 10C, the leak operated device 18 and the strain application structure 20. The system and method for detecting leaks of fluid out of the duct 10 are now ready for operation.

When liquid leaks out of a portion of the monitored shroud-covered duct 10, the leaked fluid 14 accumulates in the bottom portion 28 of the shroud 26. The rising level of fluid causes the float 30 to float on the liquid and drift closer to the duct 10. Simultaneously, the pivoting of the strain application structure 20 causes the wedge 40 to apply force onto and bend the optical conductor 12. That bend of the optical conductor 12 may be detected and reported by the available optical system, or may be enhanced to do so.

FIG. 4 shows an exemplary target block 46, which is a device for imparting a predetermined bend deformation strain to the optical conductor 12 when the wedge 40 applies force thereon. The target block 46 may be configured for example as a piece of rigid material, substantially in the shape of a parallelepiped and may be disposed between the duct 10 and the optical conductor 12. When the wedge 40 applies force on the optical conductor 12, the latter will deflect into a target block groove 46G that is disposed in the target block 40. Thereby the optical conductor 12 will deflect and conform to the shape of the target block groove 46G, in predetermined bend deformation strain. The target block 46 may have a target block base 46B that is configured for ease of disposition on the duct 10 or on another solid support.

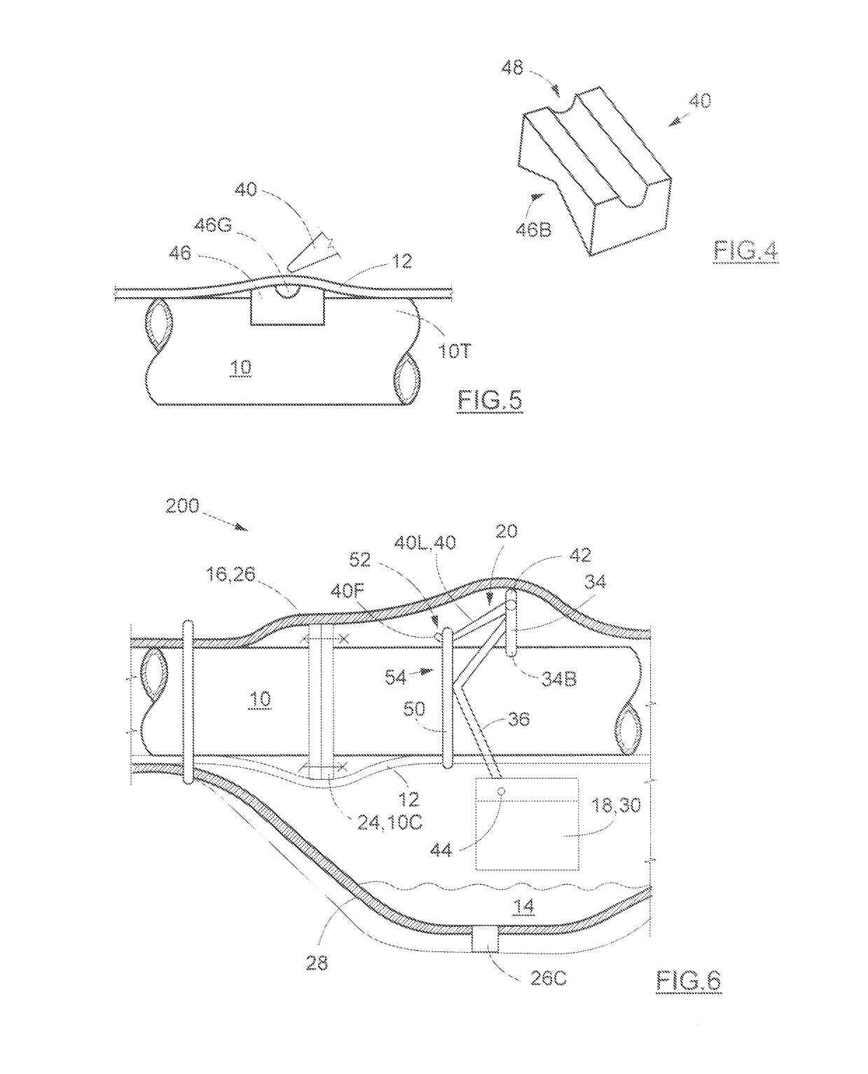

FIG. 5 is a schematic illustration of an exemplary target block 46 straddled on the duct top portion 10T but disposed under and below the optical conductor 12. It is understood that force applied by the wedge 40 on the optical conductor 12 will cause deflection thereof into the target block groove 46G. The target block 46 may be attached to the duct 10 by bands, straps, adhesive tape and the like, indicated by the numeral 22, or by other means such as glue or welding for example.

In practice, a minute leak of fluid out of the duct 10 may be acceptable. This means that it is possible to set a leak threshold above which a predetermined quantity of fluid per time is considered as a loss of fluid necessary to be detected and reported. Such a goal may be reached by opening a calibrated aperture 26C in the shroud bottom portion 28 to allow a controlled escape of leaked fluid 14 when still below the predetermined leak threshold.

FIG. 6 depicts a schematic exemplary embodiment 200 similar to the embodiment 100 shown in FIG. 2, but having an optical conductor 12 which runs along the duct bottom portion 10B of the duct 10. FIG. 6 further depicts leaked fluid 14, a leaked-fluid collector 16, a leak operated device 18, and a strain application structure 20Like the embodiment 100, the shroud 26 envelopes the selected monitored portion of the duct 10. Leaks out of the selected monitored portion of the duct 10 include leaks out of the duct fitting 10C, or other flange connection(s) 24. The shroud 26 further envelopes the leak operated device 18 and the strain application structure 20. Care is taken not to impede the free pivotal motion of the shroud 26, which may be made out of pliable and foldable fluid-tight sheet material.

The strain application structure 20 may have a lift wedge 40L, which may be coupled to the beam 32 opposite to the side of the push wedge 40P, relative to the fingers 34. A closed-loop 54 made of wire 50 for example may be disposed around the optical conductor 12 running along the duct bottom portion 10B, around the duct 10 and in a notch 52, or through a bore 52. The bore 52 may be disposed in the free end 40F of the lift wedge 40L but is not shown in the Figs.

The strain application structure 20 may be pivotally supported in balanced equilibrium on the duct top portion 10T. This means that when the strain application structure 20 is supported by the duct 10, the pull wedge 40L is just short of applying a stretch force on the loop of wire 50. However, should leaked fluid 14 retained in the bottom portion 28 of the shroud 26 lift the float 30, then the strain application structure 20 and the ears 42 will pivot clockwise.

In FIG. 6, the strain application structure 20 thus pivots clockwise about the bottom portion 38B of the arms 38, or about a hinge that is not shown in the Figs. Thereby, the lift wedge 40L will forcefully stretch the wire 50, which in turn will deform the optical conductor 12. As well known in the art, the deformation of an optical fiber, here the optical conductor 12, is detectable and reportable, and may indicate a leak of fluid.

Should only leaked fluid 14 exceeding a predetermined leak threshold be detected and reported, then it is possible to open a calibrated shroud aperture 26C in the shroud bottom portion 28, as shown in FIG. 6.

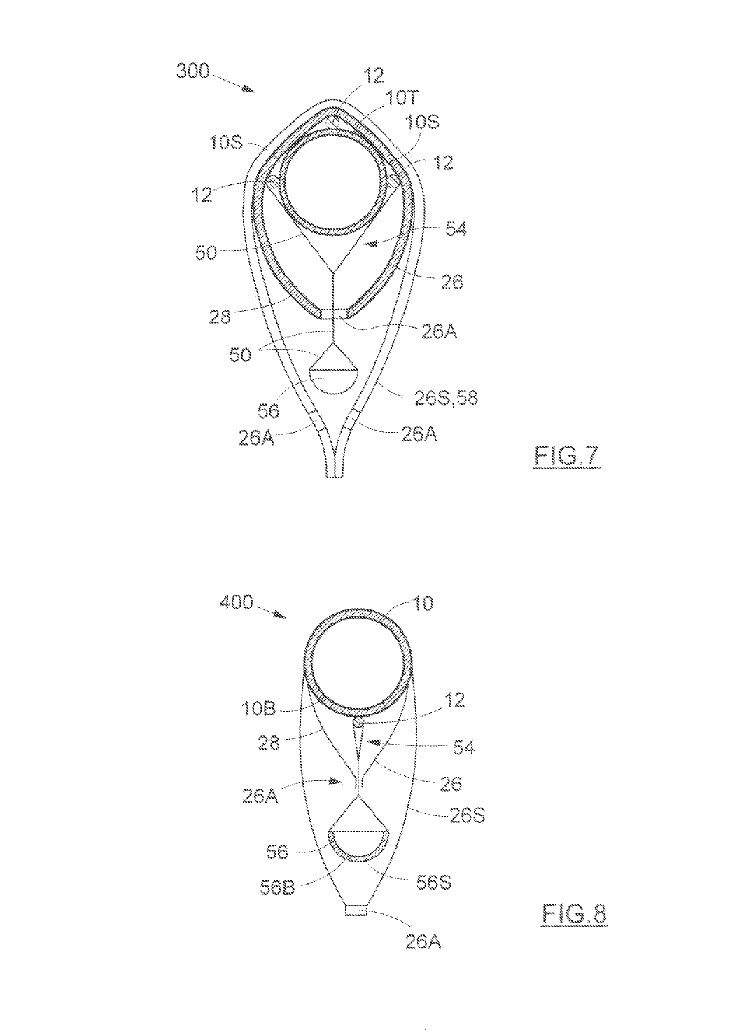

FIG. 7 depicts a further schematic exemplary embodiment 300 for detecting a leak of fluid out of an aboveground monitored portion of a duct 10 conducting liquid for example, along which runs an optical conductor 12. The partial cross-section of FIG. 7 further depicts the leaked-fluid collector 16 for collecting the leaked fluid 14 which is not shown, the leak operated device 18, and the strain application structure 20. The duct 10 may have duct fitting(s) 10C and other devices coupled thereto.

The partial cross-section depicted in FIG. 7 shows a duct 10 and three optical conductors 12 which may run along the duct top portion 10T and the duct side portions 10S. If desired, one or more than one out of those three optical conductors 12, and even though not shown in the Figs., additional optical conductors 12 may run along the length of the duct 10. The optical conductors 12 may run and cover the duct 10 from one duct side portion 10S, via the duct top portion 10T, to the other duct side portion 10S. A loose loop 54 of wire 50 may surround the duct 10 and the one or more optical conductors 12. A shroud 26 similar to that of the embodiments 100 and 200 described with respect to FIGS. 2, 3, and 6, may envelope the duct 10, the one or more optical conductors 12 and the loop 54. However, a shroud aperture 26A opened through the shroud bottom portion 28 permits to couple the loop 54 to a receptacle 56 by use of further wires 50 for example.

Leaked liquid 14 that escapes out of a monitored portion of the duct 10 into the shroud 26 and through the shroud aperture 26A may be collected in the receptacle 56. The weight of the leaked liquid will pull on the loop 54, which in turn will apply force on and deform the one or more optical conductor(s) 12. That deformation will enable detection and reporting of a leak.

If desired, a covering 58, or second shroud 26S, may be disposed to envelope the first shroud 26 and the receptacle 56. One or more shroud apertures 26A may be opened in the second shroud 26S. Should only leaked fluid exceeding a predetermined threshold of leak be detected and reported, then it is possible to open a calibrated receptacle aperture 56C in the receptacle 56, as shown in FIG. 8. In this last case, it may be preferable to dispose shroud apertures 26A in the second shroud 26S to allow the escape of leaked fluid 14.

FIG. 8 depicts a further schematic exemplary embodiment 400 for detecting leaked fluid 14 collected out of an aboveground monitored portion of a duct 10 conducting liquid along the duct bottom portion 10B of which runs an optical conductor 12.

The partial cross-section illustrated in FIG. 8 shows a duct 10 and an optical conductor 12 which may run along the duct bottom portion 10B. The partial cross-section of FIG. 8 further depicts the leaked-fluid collector 16 for collecting the leaked fluid 14 which is not shown, the leak operated device 18, and the strain application structure 20. A loop 54 made of wire 50 for example, may surround the optical conductor 12. The loop 54 may be coupled to a receptacle 56 by use of further wires 50 for example. A shroud 26 similar to that of the embodiments 100 and 200 described hereinabove with respect to FIGS. 2, 3, and 6, may envelope the duct 10, the optical conductor 12, and the loop 54. However, a shroud aperture 26A opened through the shroud bottom portion 28 permits to couple the loop 54 to a receptacle 56 by use of further wires 50 for example.

Leaked liquid 14 that may escape out of the monitored portion of the duct 10, such as out of the duct fitting 10C, may be collected in the receptacle 56 in the same manner as is described hereinabove with respect to the embodiment 300 depicted in FIG. 7. The weight of the leaked liquid will pull on the loop 54, which in turn will apply force on and deform the optical conductor 12. That deformation will allow the detection and report of a leak.

Should only leaked fluid exceeding a predetermined threshold of leak be detected and reported, then it is possible to open a calibrated receptacle aperture 56C in the receptacle bottom 56B of the receptacle 56, as shown in FIG. 8. It may be preferable to dispose shroud apertures 26A in the second shroud 26S to allow the escape of leaked fluid 14.

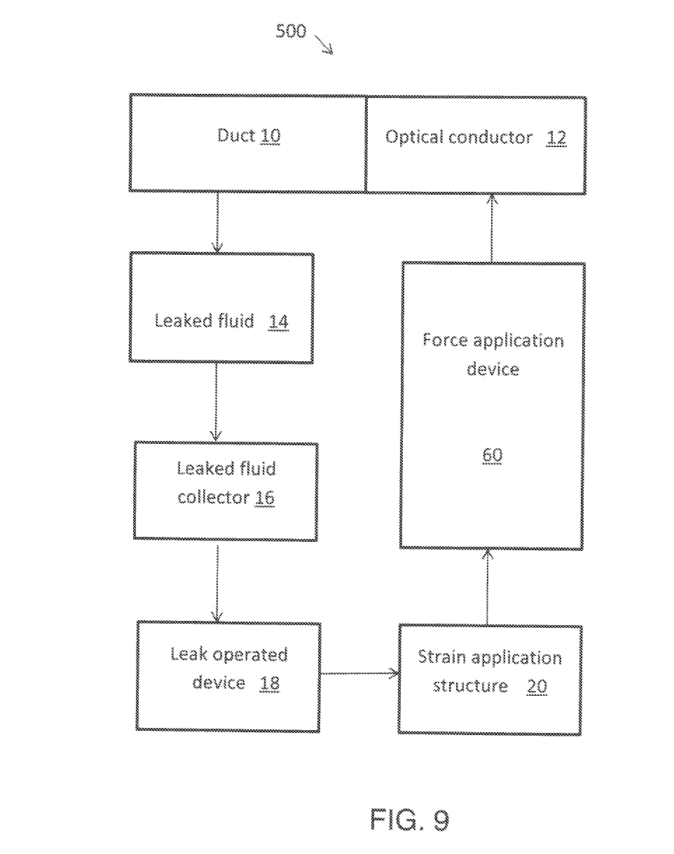

FIG. 9 is a block diagram of another embodiment 500 showing the indirect application of force to strain and deform an optical conductor 12 operative in association with a liquid conducting duct 10 along which runs an optical conductor 12. The duct 10 may have duct fitting(s) 10C which is/are not shown in FIG. 9. The block diagram of FIG. 9 further shows the leaked fluid 14, the leaked-fluid collector 16, the leak operated device 18, and a strain application structure 20. However, instead of applying force directly on the optical conductor 12, the displacement of the wedge 40 may be used to trigger and release a force application device 60. For example, the force application device 60 may release a cocked spring biasing a blade 62 that is forcefully ejected onto the optical conductor 12. Since such mechanisms are well known, drawings and description thereof are superfluous.

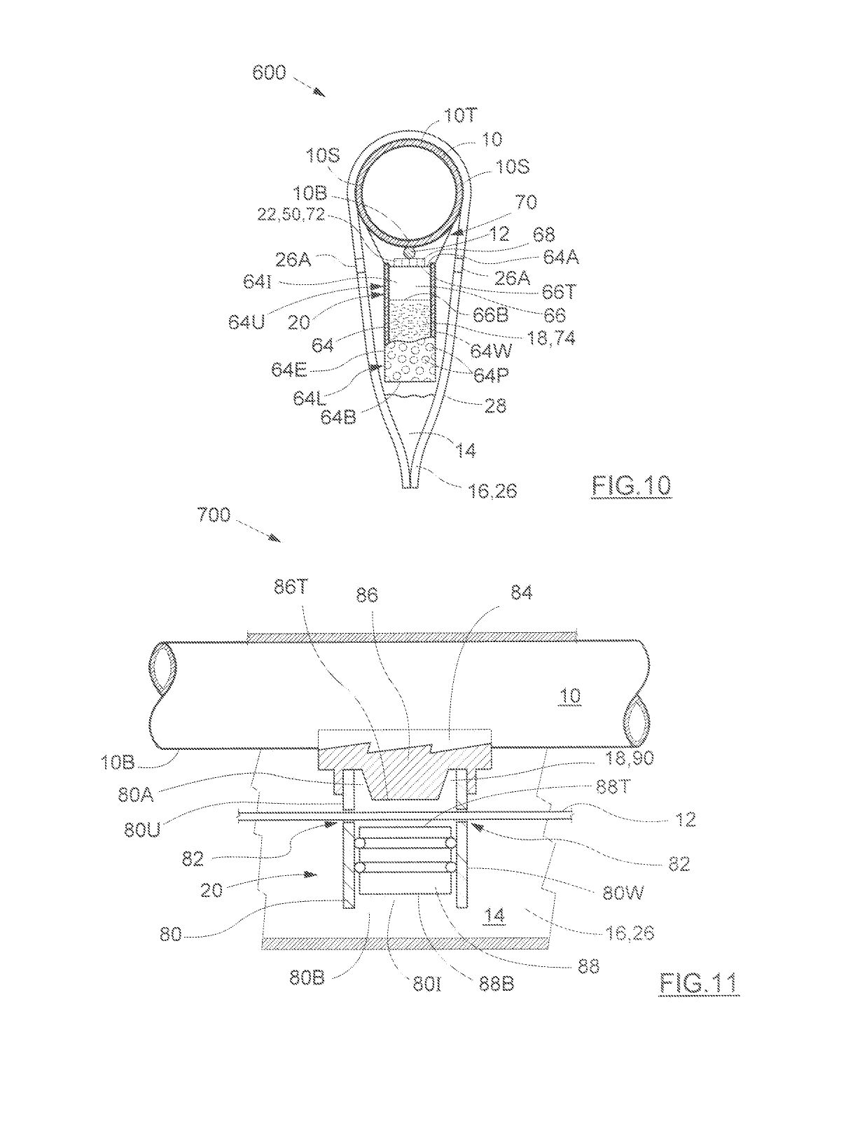

FIG. 10 illustrates still another schematic exemplary embodiment 600 for detecting a leak of fluid out of an aboveground monitored portion of a liquid conducting duct 10 along which runs an optical conductor 12. The duct 10 may have duct fitting(s) 10C which is/are not shown in FIG. 10. The partial cross-section of FIG. 10 further depicts leaked fluid 14, a leaked-fluid collector 16, a leak operated device 18, and a strain application structure 20. The optical conductor 12 may run along the duct bottom portion 10B.

The strain application structure 20 shown in FIG. 10 may be configured as a straight hollow cylindrical body 64, or as a straight hollow body of desired cross-sectional geometry, but an exemplary circular cross-section is selected for the ease of description and of drawing. The cylindrical body 64 has a cylinder bottom 64B from which rises a cylinder wall 64W to form a cylinder aperture 64A at the top thereof. The cylinder wall 64W has perforations 64P allowing liquid to pass from the exterior 64E of the cylindrical body 64 to the interior 64I thereof. Like the cylinder wall 64W, the cylinder bottom 64B may also be perforated if desired.

The leak operated device 18 is disposed in the interior 64I of the cylindrical body 64 to fill a lower portion 64L thereof, and may be supported by the cylinder bottom 64B. The upper portion 64U of the cylindrical body 64 is filled by a sliding body 66 slidably fitting into the interior 64I. The sliding body base 66B of the sliding body 66 is supported by the leak operated device 18 and the sliding body top 66T may protrude out of the cylinder aperture 64A. The sliding body top 66T may support a grid of vertically disposed blades 68 that protrude out and above of the surface thereof.

The strain application structure 20 may be hung under the duct 10 by a coupling structure 70 which is either rigid or flexible. A rigid coupling may use rods 72 or the like, and a flexible coupling may employ bands 22, straps 22, or wires 50 for example. The coupling structure 70 may stretch down from the duct top portion 10T, pass over at least one duct side portion 10S and be firmly attached to the cylindrical body 64.

The leaked-fluid collector 16, or shroud 26, may be disposed to envelope a monitored portion of the duct 10, as described hereinabove. As shown with respect the embodiments 100 and 200 related to FIGS. 2 and 6 for example, the shroud 26 may enclose a portion of the duct 10, the duct fitting 10C, the optical conductor 12 and the strain application structure 20. Although not shown in FIG. 10, a calibrated shroud aperture 26C for the release of liquid therethrough may be opened in the shroud bottom portion 28 to disregard leaks of fluid smaller than a permitted predetermined threshold leak. Furthermore, one or more shroud aperture outlets 26A may be pierced through the shroud 26, for example at about the height of the upper portion 64U or of the cylinder aperture 64A of the cylindrical body 64, to prevent the accumulation of too much fluid therein.

As one possible option chosen for the ease of description, the leak operated device 18 may be selected as a dry sponge 74. The term sponge is used to refer to substances that swell when coming in contact with a liquid.

When a leak of fluid develops, the leaked fluid 14 will accumulate in the bottom portion 28 of the shroud 26 and rise until the level of the leaked fluid reaches the perforations 64P. Leaked liquid 14 that penetrates through the perforations 64P will wet the dry sponge, which in turn, will absorb the liquid and swell. Swelling of the confined sponge 74 will push the sliding body 66 out of the cylindrical body 64 for the blades 68 to deform the optical conductor 12.

Superabsorbent polymers (SAP), also called slush powder may be selected as another option in replacement of or in for operation in association with the sponge 74. Superabsorbent polymers are polymers that can absorb and retain extremely large amounts of a liquid relative to their own mass. Water absorbing polymers are classified as hydrogels, and may swell from 30-60 times their own volume. One may thus consider the replacement of the dry sponge 74 described hereinabove with a superabsorbent polymer.

For example, a bag permeable to liquid could be partly filled with an appropriately selected SAP. The opening of the bag could be tightly closed, leaving plenty of free expansion volume, and be disposed in the interior 64I of the cylindrical body 64 instead of the sponge 74.

Details regarding hydrogel welling may be found in “Theoretical Description of Hydrogel Swelling: A Review”, by Fariba Ganji, Samira Vasheghani-Farahani, and Ebrahim Vasheghani-Farahani, in the Iranian Polymer Journal, 19 (5), 2010, p. 375-398, Available online at http://journal.ippi.ac.ir.

It may thus be aid that the leak-operated device is responsive to a substance that expands in liquid or when wetted by a liquid.

FIG. 11 illustrates still another exemplary schematic embodiment 700 for detecting leaked fluid 14 that escaped out of an above-ground monitored portion of a fluid conducting duct 10 along which runs an optical conductor 12. The duct 10 may conduct gas under pressure and may have at least one duct fitting 10C which is not shown in FIG. 11. The partial cross-section of FIG. 11 further shows leaked fluid 14, the leaked-fluid collector 16, the leak operated device 18, and the strain application structure 20. The optical conductor 12 may run along the duct bottom portion 10B.

The strain application structure 20 shown in FIG. 11 includes a sleeve 80, a cap 84, and a piston 88.

The strain application structure 20 may be selected to have a desired cross-sectional geometry, but an exemplary circular cross-section is selected for the ease of description and of drawing. The cylindrical sleeve 80 has an open sleeve bottom 80B from which rises a sleeve wall 80W to form a sleeve top aperture 80A at the top thereof. At the sleeve upper portion 80U, the sleeve wall 80W is pierce by two diametrically disposed sleeve bores 82 for the passage therethrough of the optical conductor 12. Each sleeve bore 82 holding the optical conductor 12 is hermetically sealed by means well known to those skilled in the art, to inhibit the passage of pressurized gas through the bore 82.

The sleeve top aperture 80A is closed and hermetically sealed by the cap 84. The cap 84 has a frustum 86 protruding thereout, which frustum is configured to pass through the top aperture 80A and into the sleeve 80, but just short of reaching the level of the sleeve bores 82. The frustum 86 has a frustum tip 86T that reaches down into the sleeve 80 to almost touch the optical conductor 12 that is introduced through the bore 82. A piston 88 is entered in sliding hermetical sealed fit through the open sleeve bottom opening 80B and into the interior 80I of the sleeve 80 but short of touching the optical conductor 12. The piston 88 is configured to hermetically seal the passage of pressurized gas from the sleeve bottom opening 80B to the sleeve top aperture 80A and vice versa. The optical conductor 12 is thus disposed between the frustum tip 86T and the piston top 88T.

The portion of the strain application structure 20 extending above the piston top 88T and up to the cap 84 forms a hermetically sealed chamber 90. Actually, the sealed chamber 90 implements the leak operated device 18.

In the same manner as described hereinabove with respect to the embodiment 600, the strain application structure 20 may be hung under the duct 10 by a coupling structure 70, not shown, which is either rigid or flexible. A rigid coupling may use rods 72 or the like, and a flexible coupling may employ bands 22, straps 22, or wires 50 for example.

For operation, the cap 84 may be fixedly coupled to the bottom portion 10B of the duct 10 by means described hereinabove with respect to the embodiment 600, or by other means. Thereafter, the piston 88 is entered into the sleeve 80 through the sleeve bottom opening 80B short of obstructing the bores 82. In turn, the sleeve top aperture 80A may be coupled to the cap 84 in hermetical sealed assembly by means well known to those skilled in the art. Thereby, the hermetically sealed chamber 90 contains air at ambient atmospheric pressure. Alternatively, although not shown in the Figs., it is possible to replace the air in the chamber 90 by a selected gas, by utilization of a valve that is coupled in the strain application structure 20 and is disposed in fluid communication with the chamber 90. Next, the bores 82 are used to pass the optical conductor 12 into, through, and out of the sleeve 80.

The leaked-fluid collector 16, or shroud 26, is disposed to envelope and hermetically seal the portion of the duct 10 that is monitored for leaks, as described hereinabove. As shown with respect to the embodiments 100 and 200 for example, the shroud 26 may enclose the monitored portion of the duct 10 including duct fitting(s) 10C, not shown, the optical conductor 12 and the strain application structure 20. Although not shown in FIG. 11, a pressure relief valve 92 for the release of pressurized gas therethrough may be disposed in the shroud 26 to prevent prohibitive high pressure.

With the embodiment 700 illustrated in FIG. 11, the detection of leaked gas operates as follows.

In the absence of leaked gas 14, the piston 88 is frictionally disposed in pressure equilibrium in the interior 80I of the sleeve 80 because of the substantial equality of pressure that exists on both sides of the piston 88. Ambient atmospheric pressure trapped in the chamber 90 is applied on one side of the piston 88, namely on the piston top 88T, and substantially the same atmospheric pressure is applied on the other side of the piston 88, namely on the piston bottom 88B. The friction between the piston 88 and the sleeve 80 may be configured to withstand fluctuations of the atmospheric pressure, or to be slightly displaced thereby.

When gas leaks out of the monitored portion of the duct 10, pressurized gas, indicated as leaked fluid 14, fills the leaked-fluid collector 16, or shroud 26. Pressurized gas acting on the piston bottom 88B will push the piston 88 upwards against the lower pressure contained in the chamber 90. Thereby, the piston top 88T will apply force on the optical conductor 12 which will be squeeze against the frustum top 86T and undergo stain deformation, which may be detected, reported and indicate a leak. If desired, a one-way valve may be disposed in the chamber 90 to allow the escape of gas thereout.

Since the sealed chamber 90 responds to the presence of leaked fluid 14, the sealed chamber 90 is actually the leak operated device 18.

A method and a system have thus been described hereinabove for detecting leaks from a duct 10. The system may include a mechanical mechanism including a leaked fluid collector 16, a leak-operated device 18, and a strain application structure 20. The strain application structure 20 may trigger a force application device 60 to apply a strain deformation on the at least one optical conductor 12. It is noted that the method and the system described hereinabove may be implemented in retrofit, thus for installation and operation in retrofit in an existing installation. Furthermore, the at least one optical conductor 12 may run along the duct 10 in a disposition selected from the group including a duct top portion 10T, a duct side portion 10S, and a duct bottom portion 10B.

### INDUSTRIAL APPLICABILITY

The exemplary embodiments described hereinabove as well as variations thereof are applicable at least in the pipeline production and operation industry.

### REFERENCE SIGNS LIST

Ref. Item
G ground
10 duct
10B duct bottom portion
10C duct fitting
10T duct top portion
10S duct side portion
12 optical conductor
14 leaked fluid
16 leaked-fluid collector
18 leak operated device
20 strain application structure
20T top portion of the strain application structure 24
22 band or strap
24 flange connection
26 shroud
26A shroud aperture outlet
26C calibrated shroud aperture
26S second shroud
28 shroud bottom portion
30 float
32 beam
34 finger
34B finger bottom portion
36 leg
36F free portion of leg 36
38 arm
38E arm end
40 wedge
40F free end of wedge
40L lift wedge
40P push wedge
40T wedge tooth
42 ear
44 fastener
46 target block
46B target block base
46G target block groove
50 wire
52 notch or bore
54 loop
56 receptacle
56B receptacle bottom
56C calibrated receptacle aperture
58 covering
60 force application device
62 blade
64 cylindrical body
64A cylinder aperture
64B cylinder bottom
64E exterior of the cylindrical body 64
64I interior of the cylindrical body 64
64L lower portion of the cylindrical body 64
64P perforations in the cylinder wall 64W
64U upper portion of the cylindrical body 64
64W cylinder wall
66 sliding body
66B sliding body base
66T sliding body top
68 blades
70 coupling structure
72 Rod
74 sponge
80 sleeve
80A sleeve top aperture
80B sleeve bottom opening
80I sleeve interior
80U sleeve upper portion
80W sleeve wall
82 bore
84 cap
86 frustum
86T frustum tip
88 piston
88B piston bottom
88T piston top
90 sealed chamber
92 pressure relief valve

1. A method for detecting a leak of fluid out of a fluid-carrying duct operating in association with at least one optical conductor, the method comprising the steps of:
providing a leaked-fluid collector for collecting fluid leaking out of the duct,
providing a leak-operated device responding to fluid that leaked out of the duct, and
providing a strain application structure using the leak-operated device for applying strain deformation on the at least one optical conductor.

2. The method of claim 1, wherein the leaked-fluid collector accumulates fluid that is a liquid or a gas.

3. The method of claim 1, wherein the leaked-fluid collector is disposed to envelope a monitored aboveground portion of the duct.

4. The method of claim 3, wherein the aboveground monitored portion of the duct includes at least one duct fitting.

5. The method of claim 1, wherein the leaked-fluid collector is controllably sealed.

6. The method of claim 1, wherein the strain application structure operates a force application device which applies strain on the at least one optical conductor.

7. The method of claim 1, wherein the at least one optical conductor is supported by a target block.

8. The method of claim 1, wherein the leak-operated device is buoyant on the leaked fluid.

9. The method of claim 1, wherein the leak-operated device is a substance that expands in liquid or when wetted by liquid.

10. The method of claim 1, wherein the leak-operated device is a hermetically sealed chamber.

11. A system for the detection of leaked fluid that leaked out of a fluid-carrying duct associated with at least one optical conductor, the system comprising:
a leaked-fluid collector configured to collect the leaked fluid,
a leak-operated device configured to respond to the leaked fluid, and
a strain application structure configured to use the leak-operated device to apply a strain deformation on the at least one optical conductor.

12. The system of claim 11 wherein the leaked fluid collector, the leak-operated device and the strain application structure form a mechanical mechanism.

13. The system of claim 11 wherein the strain application structure releases a force application device to apply a strain deformation on the at least one optical conductor.

14. The system of claim 11 being configured for installation and operation in retrofit.

15. The system of claim 11 wherein the leaked-fluid collector is configured to allow a predetermined leak threshold.

16. The system of claim 11 wherein the leaked-fluid collector is made out of a material selected alone and in combination from a group including a rigid material, a semi-rigid material, and a foldable and pliable material.

17. The system of claim 11 wherein the at least one optical conductor runs along the duct in a disposition selected from a group including a duct top portion, a duct side portion, and a duct bottom portion.

18. The system of claim 11 further comprising a target block configured to impart a predetermined bend deformation strain to the optical conductor.

19. A system for the detection of leaked fluid that leaked out of a fluid-carrying duct associated with at least one optical conductor, the system having a mechanical mechanism comprising:
a leaked-fluid collector configured to collect the leaked fluid,
a leak-operated device configured to respond to the leaked fluid, and a strain application structure configured to use the leak-operated device to apply a strain deformation on the at least one optical conductor.

20. A method for detecting a leak of fluid out of a fluid-carrying duct operating in association with at least one optical conductor and a mechanical mechanism, the method comprising the steps of:
providing a leaked-fluid collector for collecting fluid leaking out of the duct,
providing a leak-operated device responding to fluid that leaked out of the duct, and
providing a strain application structure using the leak-operated device for applying strain deformation on the at least one optical conductor.
